(19) United States
(12) Patent Application Publication
(10) Pub. No.: US 2016/0324077 A1
(43) Pub. Date: Nov. 10, 2016

(54) PORTABLE HYDROPONIC GREENHOUSE ASSEMBLY AND METHOD OF USING SAME

(71) Applicant: HELICAL HOLDINGS, LLC, LAFAYETTE, LA (US)

(72) Inventors: KOHLAR T. FRANTZEN, LAFAYETTE, LA (US); DYLAN J. RATIGAN, LAKE PLACID, NY (US)

(21) Appl. No.: 15/146,667

(22) Filed: May 4, 2016

Related U.S. Application Data
(60) Provisional application No. 62/157,156, filed on May 5, 2015.

(51) Int. Cl. A01G 9/14; H02S 10/40; H02S 20/30; A01G 1/00

(52) U.S. Cl. CPC A01G 9/14; A01G 1/001; H02S 10/40; H02S 20/30

(57) ABSTRACT

A portable hydroponic greenhouse assembly for use in integrating a community hub for commercial transactions. A portable hydroponic greenhouse assembly for use in providing a power source and a backup power supply that encompass any necessary components in order to allow for the production of food, water filtration, power, and/or communications for a variety of different purposes, including, but not limited to, community development, commercial transactions, or education and distribution. A relocatable hydroponic greenhouse assembly for use in assisting a community in providing food, power, water, and communications at any desired location where said portable assembly can be shipped and delivered.

### CROSS REFERENCES TO RELATED APPLICATION

PRIORITY OF U.S. PROVISIONAL PATENT APPLICATION Ser. No. 62/157,156, FILED May 5, 2015, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to a self-contained, autonomous, semi-automated, and re-locatable commercial scale hydroponic greenhouse assembly for use in integrating a community hub for commercial transactions, educating a variety of different people on their ability to grow and provide food, or any other similar use. More particularly, by way of illustration, but not limitation, other similar uses for said portable assembly comprise having a power source and a backup power supply (“HUB”) that encompass any necessary components in order to allow for the production of food, water filtration, power, and/or communications for a variety of different purposes, including, but not limited to, community development, commercial transactions, or education and distribution. More particularly, still, the present invention pertains to a relocatable hydroponic greenhouse assembly for use in assisting a community in providing food, power, water, and communications at any desired location where said portable can be shipped and delivered.

2. Brief Description of the Prior Art

Traditionally, conventional greenhouses allow for more control over a particular growing environment for a variety of different plants. For example, generally, conventional greenhouses provide for controlled temperatures, particular amounts of light or shade, irrigation, fertilizer application, and/or humidity levels. Further, conventional greenhouses can be used to overcome deficiencies in quality and location of land, and thus, can be used to increase food production when environmental factors are less than adequate.

Additionally, the historic installation of conventional greenhouses involves a rigorous process of cementing a plurality of posts and columns into a ground surface for use as a permanent, fixed system, which then creates an immovable greenhouse structure. Further, the historic installation of conventional greenhouses includes a need for a variety of different parts and time spent related to installing and locating or replacing any missing parts. However, this conventional application of greenhouses is not useful during disaster situations or military applications, in which said traditional greenhouses cannot be used, removed, or stored safely. Therefore, conventional greenhouses cannot be used as a proper food source and cannot provide an adequate food supply during these emergency settings.

Further, the conventional model of agriculture and farming is not sustainable due to an increase in use of land and water and due to rising food costs. As a result, there is a need for a different approach to farming—where students and communities can be taught how to grow and sell their own food, where less land is used, where water is conserved, reused, and/or recirculated at every point of use, and where a greenhouse can be reused, relocated, and/or reinstalled at different locations, as necessary. Thus, the portable greenhouse assembly of the present invention provides a solution to this need, wherein the present invention produces a substantially significant increase in the number of crops that are yielded, while requiring a significantly less amount of water as compared to a conventional, soil-based growth method. Further, the portable greenhouse assembly diminishes the need for pesticides and herbicides, thereby providing for a more natural and healthier end-product.

### SUMMARY OF THE INVENTION

The present invention comprises a portable, commercial scale hydroponic greenhouse and head house “hub” assembly and a method of integrating food, energy, water, and communication within said portable greenhouse assembly. The portable greenhouse assembly of the present invention comprises a container member that is pre-configured and packed to arrive at a desired location and be unpacked onsite for installation as a commercial hydroponic greenhouse assembly and commercial transaction hub on any type of property. By way of illustration, but not limitation, the assembly can comprise a solar power or a battery back-up power source, wherein the assembly can arrive by way of its own power for any tools that are necessary in assembling and installing the greenhouse assembly of the present invention. As a result, said greenhouse assembly is able to easily and efficiently train and educate a number of different people on a standard-sized product, whereby said people may then be able to use this training to be able to earn a living, create a plurality of different jobs, grow food and vegetation, or otherwise provide food, power, water, and communication/education to communities, both locally and globally.

In a preferred embodiment, said portable greenhouse assembly comprises a customized and repurposed shipping container that allows the present invention to be transported and delivered to a particular site. When delivered, said container member beneficially encompasses all of the components of the portable greenhouse assembly that are necessary for installation. Internal packaging of the portable greenhouse assembly generally comprises a commercial scale greenhouse member, a water purification system, a pre-integrated and pre-programmed environmental and electrical control system for all ancillary equipment that requires electrical service, a plurality of hand tools that are necessary for construction of said assembly, and a first growth cycle of consumables (such as, for example, seeds growing cubes, filters, and nutrients). The containers, or pallets, that are used for shipping the contents of said greenhouse assembly can be repurposed and used as receptacles onsite for either additional storage or use as a potential store front; then, the pallets can be reused in order to repack all of the equipment into the container, thereby being able to relocate said assembly as necessary. As a result, the portable greenhouse assembly is not a fixed structure and can be moved and relocated to any desired location.

By way of illustration, but not limitation, once the portable greenhouse assembly has been delivered and unloaded at a desired site, a solar racking system can then be unpacked, installed, and opened, thereby providing a necessary power source in order to charge any tools that are required for said greenhouse installation; however, it is to be observed that any other similar means of supplying a power source or energy source may also be used.

Further, in a preferred embodiment, said portable greenhouse assembly of the present invention comprises a number of different components, including, but not limited to: a plug-and-play electrical system for use in ease of training and installation; a plurality of columns that can be either bolted into a ground surface or attachably connected, thereby allowing said greenhouse assembly of the present invention to be removed or relocated; a standardized location for an electrical control system and a water filtration system for use in ease of training and installation; and, an educational training hub that standardizes training on commercial farming capabilities of the greenhouse assembly of the present invention. The different components of said portable greenhouse assembly are generally installed in a pre-designated position within said greenhouse assembly, thereby creating a method of installation and assembly that is generally easier and more efficient for a variety of different users at various locations, either locally or globally, and mitigates a need for specific trades on-site that are otherwise necessary for installation and assembly.

In a preferred embodiment, said portable greenhouse assembly of the present invention comprises a plurality of structural posts and/or columns that are designed to attachably connect and mate into a plurality of mating connections. As a result, said detachable posts allow the portable greenhouse assembly to be assembled and disassembled relatively easily and efficiently and remain substantially portable and moveable, and thus, otherwise be installed as a temporary structure rather than a permanent structure. Thus, this design is useful for disaster and/or emergency situations in which the structure may be removed and stored safely in its container during any particular threat, any military application where bases are relocated, or any other situation where it could be helpful to remove a greenhouse for later reuse.

Additionally, the portable greenhouse assembly of the present invention has several advantages, such as, for example: being able to protect a variety of families and communities against disruption in supply or distribution of produce or vegetation; being able to empower different types of people by way of an assembly that enables people in different environments, whether urban or rural, to farm and cultivate; being able to provide training to schools to enable students to gain skills that are necessary in order to grow produce and vegetation for either self-consumption or in order to become agricultural entrepreneurs; being able to create a number of direct opportunities for veteran employment, while empowering returning service personnel with a new set of equipment and expertise; being able to allow for a leasing model or franchise models that do not currently exist for conventional greenhouse operations; being able to provide non-profit entities, foundations, food banks, emergency relief entities, or any other similar business with the ability to feed, provide clean water, provide a power source, and provide communication to anywhere in the world; and, being able to provide a quantifiable production of produce and vegetation, while having the ability to re-locate at any desired time.

As a result, the present invention offers communities a standardized, market-ready assembly that creates a relatively faster and easier path to local learning and resource hubs, thereby providing a means to serve as farmers markets and sources of community pride and independence, while also allowing for visitors to be able to utilize the power source, access clean water, and buy fresh, locally grown produce and vegetation.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side perspective view of a preferred embodiment of a portable greenhouse assembly of the present invention.

FIG. 2 depicts a side perspective view of a preferred embodiment of a portable greenhouse assembly of the present invention being transported and relocated within a container member.

FIG. 3 depicts a side perspective view of a preferred embodiment of a portable greenhouse assembly of the present invention.

FIG. 4 depicts a perspective view of a preferred embodiment of an electrical control system of a portable greenhouse assembly of the present invention.

FIG. 5 depicts a side perspective view of a preferred embodiment of a container member of a portable greenhouse assembly of the present invention.

FIG. 6 depicts a perspective view of a preferred embodiment of a water filtration system of a portable greenhouse assembly of the present invention.

FIG. 7 depicts an end view of a preferred embodiment of an interior space within a greenhouse member of a portable greenhouse assembly of the present invention.

FIG. 8 depicts a side view of a preferred embodiment of an interior space within a greenhouse member of a portable greenhouse assembly of the present invention comprising an electrical control system panel, a water filtration system, and a reservoir assembly.

FIG. 9 depicts a perspective view of a preferred embodiment of a reservoir assembly of a portable greenhouse assembly of the present invention.

FIG. 10a depicts a side view of a preferred embodiment of a helical screw mating connection of a greenhouse assembly of the present invention.

FIG. 10b depicts a side view of a preferred embodiment of a concrete mating connection of a greenhouse assembly of the present invention.

FIG. 10c depicts an aerial view of a preferred embodiment of a helical screw mating connection of a greenhouse assembly of the present invention.

FIG. 10d depicts an aerial view of a preferred embodiment of a concrete mating connection of a greenhouse assembly of the present invention.

FIG. 10e depicts a side view of an alternate embodiment of a connection means of a greenhouse assembly of the present invention.

FIG. 11a depicts a side view of a preferred embodiment of a leg assembly of a table assembly of the present invention in an unassembled configuration.

FIG. 11b depicts a side view of a preferred embodiment of a leg assembly of a table assembly of the present invention with a single leg in an assembled configuration.

FIG. 11c depicts a side view of a preferred embodiment of a leg assembly of a table assembly of the present invention with at least two legs in an assembled configuration.

FIG. 11d depicts a side view of a preferred embodiment of a leg assembly of a table assembly of the present invention with a plurality of legs in an assembled configuration.

FIG. 11e depicts a side view of a preferred embodiment of a leg assembly of a table assembly of the present invention in a fully assembled configuration.

### DETAILED DESCRIPTION OF A PREFERRED EMBODIMENT

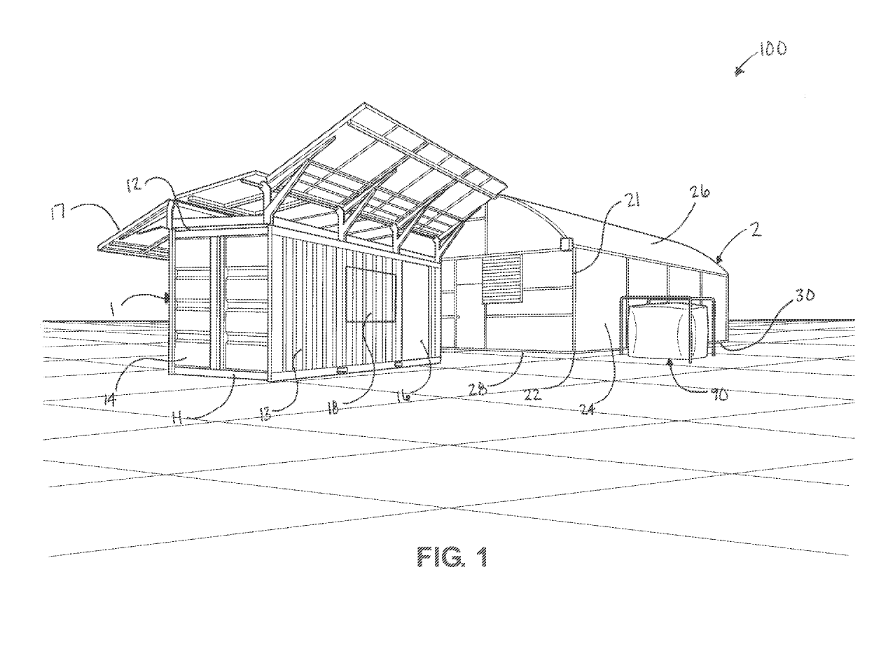

Referring to the drawings, FIG. 1 depicts a perspective view of a portable greenhouse assembly 100 of the present invention in a fully constructed configuration, generally comprising a container member 1 and a greenhouse member 2. Greenhouse assembly 100 of the present invention can be manufactured in a variety of different dimensions. In a preferred embodiment, container member 1 has dimensions of approximately 40 feet in length, 8 feet in width, and 8 feet in height, and can be constructed from a relatively rigid material, or any other material exhibiting desired characteristics; in a preferred embodiment, greenhouse member 2 has dimensions of approximately 2,880 square feet, and can be constructed from a relatively rigid material, or any other material exhibiting desired characteristics.

As depicted in FIG. 1, container member 1 generally comprises substantially planar base member 11, substantially planar top member 12, substantially planar side members 13, and substantially planar end members 14. Base member 11 and top member 12 are oriented substantially parallel to each other, while side members 13 are oriented substantially parallel to each other; end members 14 are oriented substantially parallel to each other and substantially perpendicular to side members 13. Thus, base 11, top 12, sides 13, and ends 14 form a substantially box-like configuration, wherein said base 11, top 12, sides 13, and ends 14 cooperate to form an inner space or chamber 15.

In a preferred embodiment, ends 14 can be opened and/or closed as necessary, thereby allowing a user to beneficially remove a plurality of contents from within container member 1 as greenhouse assembly 100 installation is underway. In addition, sides 13 can comprise at least one door member 16, thereby providing access to inner chamber 15 of container member 1 once greenhouse assembly 100 has been constructed. Door member 16 is attachably connected to side members 13 of container member 1 via a plurality of hinges, or other secure attachment means, and can open in a relatively outward direction, away from container member 1. As a result, ends 14 provide access to inner chamber 15 when greenhouse assembly 100 is in the process of being built, and doors 16 provide access to within inner chamber 15 after greenhouse assembly 100 has been built and when container member 1 is further utilized as a community hub.

Additionally, in a preferred embodiment, by way of illustration, but not limitation, container member 1 generally comprises a solar panel system, or solar photovoltaic panel 17, for use in providing an energy and power source to greenhouse assembly 100 in order to charge any necessary power tools that are required for further greenhouse assembly installation. Solar panel system 17 can be installed and attachably connected to top member 12 of container member 1 of the present invention, wherein solar panel system 17 can alternate between a relatively collapsed position and a fully deployed position, thereby providing a solar-powered generation system, and ultimately a power source, for portable greenhouse assembly 100. By way of illustration, but not limitation, said solar photovoltaic panel system can be substantially of a type disclosed in U.S. Published Patent Application 2015/0013750 to Meppelink et al., which is for all purposes incorporated herein by reference. It is to be observed that alternate means of providing a power and/or energy source to portable greenhouse assembly 100 may also be used, as necessary.

Still referring to FIG. 1, greenhouse member 2 generally comprises a plurality of posts 21, or columns, that are used to construct greenhouse member 2 of the present invention. Although not depicted in FIG. 1, by way of illustration, but not limitation, greenhouse member 2 can utilize either a substantially helical screw connection, a concrete connection, or a mechanical bracket connection for use in installing greenhouse member 2 and connecting greenhouse posts 21 to a ground surface; said connection means allow greenhouse member 2 to be assembled and disassembled, thus creating a temporary structure that can be transferred and moved as necessary.

In a preferred embodiment, a plurality of footings 22 can be installed and mounted between each column 21 of greenhouse member 2 in order to provide a foundation around an entire floor surface of greenhouse member 2. Footings 22 generally comprise a substantially planar structure that are manufactured from a relatively rigid material, such as, for example, a metal material, or any other substantially similar material exhibiting like characteristics. Further, footings 22 are generally mounted to a relatively bottom end 23 of each column 21, thus being located at or slightly above a ground surface in order to provide a foundation around greenhouse member 2. Footings 22 also provide a location in which hardware can be attached, thereby providing a means to attach and connect a plurality of walls 24 for greenhouse member 2. Further, footings 22 can also provide a barrier between an outside environment and an inside location 25 of greenhouse member 2, thereby preventing air loss and insect access into and out of greenhouse member 2.

In a preferred embodiment, when initial construction and set-up of greenhouse member 2 of the present invention is complete and greenhouse posts 21 and footings 22 have been installed and connected, a covering, or glazing member 26, is beneficially draped over a top surface of the skeletal structure of said greenhouse member 2 and secured into place via a plurality of fasteners that are located around a perimeter of the greenhouse member structure 2. Glazing member 26 can be manufactured from a relatively plastic material, or any other similar material exhibiting like characteristics, such as, for example, a relatively soft, malleable and flexible plastic material, or a relatively hard polycarbonate material.

Still referring to FIG. 1, in a preferred embodiment, a berm 30, or a relatively raised border, can be created along an entire base of greenhouse member 2 by way of packing a variety of different materials (such as, for example, sand, dirt, and/or rock) along a base of each wall 24 of greenhouse member 2 in order to cover footings 22, thereby further preventing air loss or insect ingress and egress from greenhouse member.

In an alternate embodiment, although not illustrated in FIG. 1, depending on a particular geographical location and climate zone of a greenhouse assembly 100 site, a roll-up wall and screen system, or an evaporative cooling system can be included within container member 1 upon arrival and thus installed within greenhouse member 2, as necessary. Further, although not depicted in FIG. 1, additional equipment, such as, for example, a heater, a light, an air-flow fan, or a carbon dioxide generator can also be installed within greenhouse member 2, as necessary.

Once greenhouse member 2 of the present invention is fully enclosed and able to provide an insect-free environment, a plurality of interior components of greenhouse member 2 can then be removed from container member 1, and thus, placed in their desired locations within greenhouse member 2.

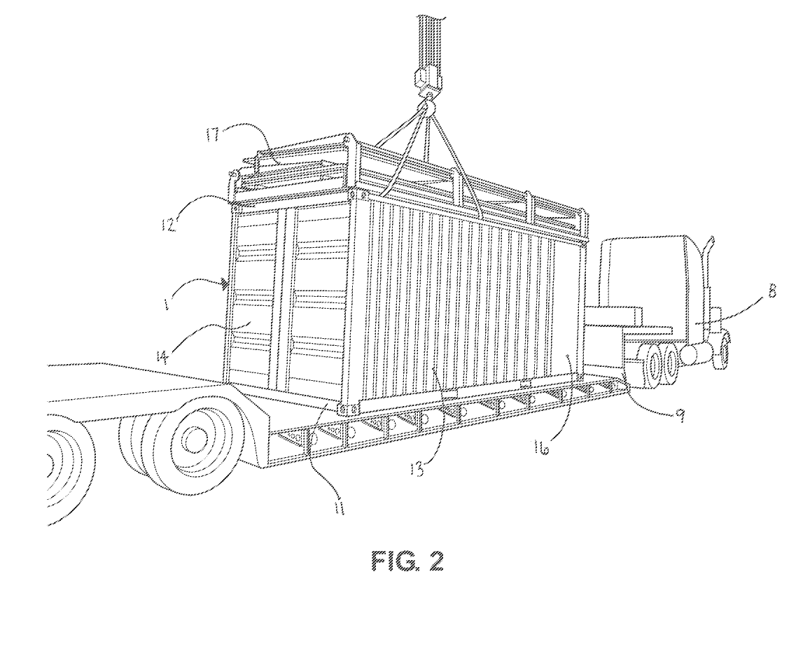

FIG. 2 depicts a perspective view of portable greenhouse assembly 100 of the present invention being transported and relocated to a different location within container member 1. By way of illustration, but not limitation, greenhouse assembly 100 can be transported by way of a truck 8 and trailer hitch connection 9, or any other similar transportation means, such as, for example, by way of a skid connection.

When in operation, container member 1 can be transported and delivered to a particular site or desired location as necessary. Although not illustrated in FIG. 2, upon initial delivery of container member 1, internal packaging of container member 1 comprises a deconstructed greenhouse member 2, a water filtration system 40, an electrical control system 50, a plurality of hand tools that are necessary for construction and erection of greenhouse assembly 100, and a first growth cycle of consumables (including, but not limited to, a plurality of seeds, growing cubes, filters, and/or nutrients). Once container member 1 has been delivered, a user can then unload the initial contents of container member 1 and begin constructing greenhouse member 2. Container member 1 can then be repurposed and used as a community hub for a variety of purposes, including, but not limited to, a store front for commercial transactions, education, or for use as a backup power supply.

Alternatively, container member 1 can be transported and delivered to a particular site or desired location, wherein container member 1 only comprises a power source, thereby eliminating any aspects or component parts of deconstructed greenhouse member 2 during shipment. Thus, as a result, depending on a particular user's needs, container member 1 can be shipped and transported with deconstructed greenhouse member 2 and all of the component parts for greenhouse member if a user is focused on an agricultural aspect of the present invention, or container member 1 can be shipped and transported without greenhouse member, thereby allowing container member 1 to solely provide a user with a means for a power source.

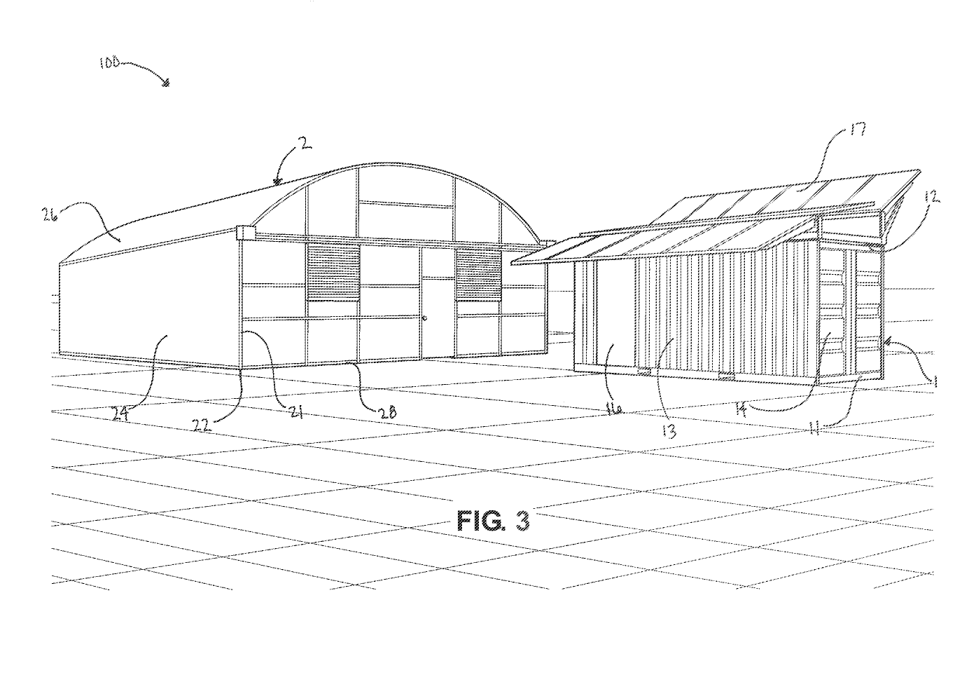

FIG. 3 depicts a side perspective view of portable greenhouse assembly 100 of the present invention comprising container member 1 and greenhouse member 2. Container member 1 comprises base member 11, top member 12, side members 13, and end members 14, wherein base 11, top 12, sides 13, and ends 14 cooperate to form inner chamber 15. Further, container member 1 comprises solar photovoltaic system 17 that is attachably installed to top member 12 for use in providing an energy and power source to greenhouse assembly 100 of the present invention.

Still referring to FIG. 3, greenhouse member 2 comprises a plurality of posts 21, or columns, that are used to construct greenhouse member 2 of the present invention. Additionally, footings 22 can be installed and mounted between each column 21 of greenhouse member 2 in order to provide a foundation around an entire floor surface of said greenhouse 2. Said footings 22 provide a location in which hardware can be attached, thereby providing a means to attach and connect walls 24 for greenhouse member 2, and also provide a barrier between an outside environment and inner space 25 of greenhouse member 2, thereby preventing air loss and insect access into and out of greenhouse assembly 2.

Once greenhouse posts 21 and footings 22 have been installed and connected, covering 26 is beneficially draped over a top surface of the skeletal structure of greenhouse member 2 and secured into place via a plurality of fasteners that are located around a perimeter of the greenhouse member structure 2.

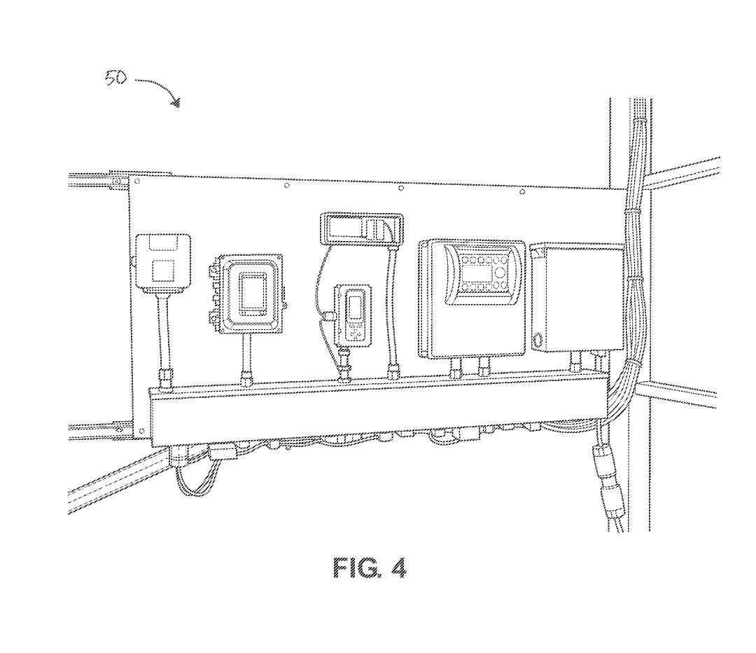

FIG. 4 depicts a front view of an electrical control system 50 of greenhouse assembly 100 of the present invention. Electrical control system 50 can be pre-assembled, pre-wired, pre-programmed, and integrated onto a panel that can be mounted to an inner surface of wall 24 within greenhouse member 2, or can have any other desired placement and orientation for an alternate mode of installation. Further, electrical control system 50 comprises a number of environmental control and electrical components that automate control and functionality of ancillary devices, including, but not limited to, a fan(s), motor(s), pump(s), receptacle(s), a plurality of switches, and a plurality of lights. In addition, it is to be observed that specific configurations and component parts to electrical control system can vary depending on environmental factors, or any other like circumstances.

Electrical control system 50 can be pre-designed and pre-wired with instructions that enable said components to be beneficially plugged into electrical control system panel 50, thereby minimizing a need for a specialized field electrician to install and set-up electrical control system 50, and thus, otherwise greatly reduce the amount of time that is necessary to install said components. In a preferred embodiment, after installation and connection of component parts of electrical control system 50, greenhouse member 2 can then be connected to a power source within container member 1 via at least one power cord, or any other similar connection means. As a result, electrical control system 50 can beneficially provide an electrical connection and energy source to greenhouse assembly 100.

Electrical control system 50 avoids hard-wiring on-site by using a standardized integration of a plurality of electrical and control components as well as a pre-wired breaker panel and trough to connect all ancillary devices, such as, for example, a fan(s), a light(s), gearboxes, and pumps that are necessary to automate the internal environment of the greenhouse via a plurality of pre-labeled outlets affixed to a substrate panel. Each ancillary device is equipped with a labeled, electrical “pig tail” of precise length to allow the uniform installation of the component that is plugged into the trough of electrical control panel 50. Likewise, electrical control panel 50 connects to container member 1 in a relatively quick-connect fashion without the need for on-site hard wiring. This allows for the quick installation and removal of electrical control system 50.

Still referring to FIG. 4, electrical control system panel 50 comprises a connection in the lower right that allows electrical control panel 50 to be quickly connected to the power source provided by container member 1. Power flows from a power source location into a breaker panel, which is wired to the control equipment and to the outlet trough. This in turn allows the control equipment to automate the functions of the ancillary equipment that impacts the internal environment of the greenhouse assembly 100.

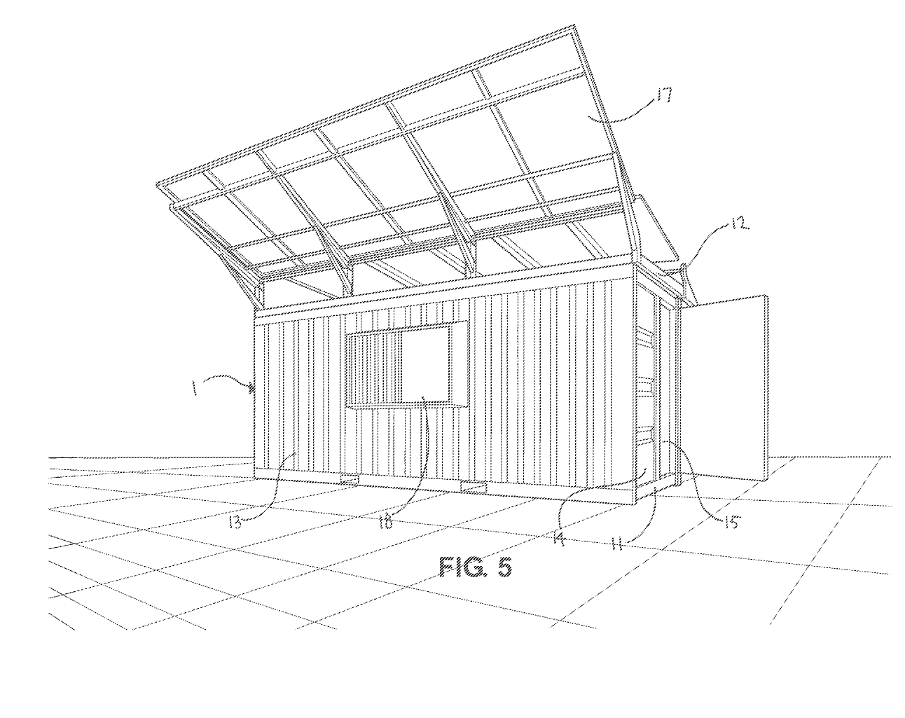

FIG. 5 depicts a side perspective view of container member 1 of the present invention. Container member 1 generally comprises base member 11, top member 12, side members 13, and end members 14, wherein said base 11, top 12, sides 13, and ends 14 cooperate to form an inner space or chamber 15. In a preferred embodiment, during initial greenhouse assembly installation, ends 14 can be opened and/or closed as necessary, thereby allowing a user to beneficially remove a plurality of contents from within inner chamber 15 of container member 1 as greenhouse assembly 100 is being installed. In addition, sides 13 can comprise at least one door member 16, thereby providing access to inner chamber 15 of container member 1 once greenhouse assembly 100 has been constructed. As a result, ends 14 provide access to inner chamber 15 when greenhouse assembly 100 is in the process of being built, and doors 16 provide access to within inner chamber 15 after greenhouse assembly 100 has been built and when container member 1 is being further utilized as a store front for a community hub, or for any other like purposes.

Additionally, in a preferred embodiment, by way of illustration, but not limitation, container member 1 generally comprises solar photovoltaic panel system 17 for use in providing an energy and power source in order to charge any necessary power tools that are required for further greenhouse assembly 100 installation. Solar panel system 17 can be installed and attachably connected to top member 12 of container member 1 of the present invention, thereby providing a solar-powered generation system for greenhouse assembly 100.

Once container member 1 has been delivered, a user can then unload the initial contents of container member 1 and begin constructing greenhouse member 2. Container member 1 can then be repurposed and used as a community hub for a variety of purposes, including, but not limited to, a store front for commercial transactions, education, or for use as a backup power supply. Thus, sides 13 comprise a window member 18 that slidably opens and closes, thereby allowing for container member 1 to act as a store front during commercial transactions, wherein customers can approach window member 18 to order and purchase produce or other vegetation, as desired.

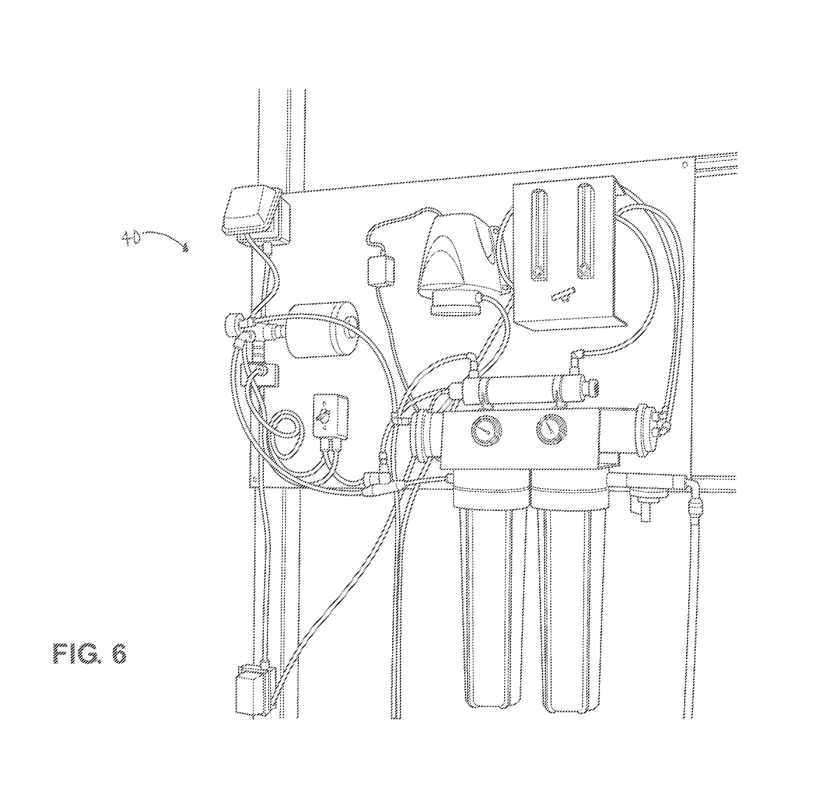

FIG. 6 depicts a front view of a water filtration system panel 40 of portable greenhouse assembly 100 of the present invention. Water filtration system 40 can be mounted to an inner surface of wall 24 within greenhouse member 2; further, water filtration system 40 avoids the need for complex, on-site plumbing and assembly of water filtration devices via use of a pre-plumbed and pre-wired integration of components, including filters, switches, pumps, and control and monitoring equipment that are mounted to a substrate panel. Thus, water filtration system 40 is built for quick, mechanically fastened installation to greenhouse wall 24. Likewise, water filtration system 40 connects to electrical control panel 50 in a quick-connect fashion without the need for on-site hard wiring. As a result, this allows for the quick installation and removal of water filtration system 40.

Still referring to FIG. 6, water filtration system 40 comprises a quick connection in the lower left location that allows the water filtration equipment to be powered by electrical control panel system 50. The filtration panel includes multiple pre-filters, ultraviolet filtration, reverse osmosis filtration, a booster pump, a chemical injection pump, control and switch equipment, and monitoring equipment that allow water to be filtered onsite.

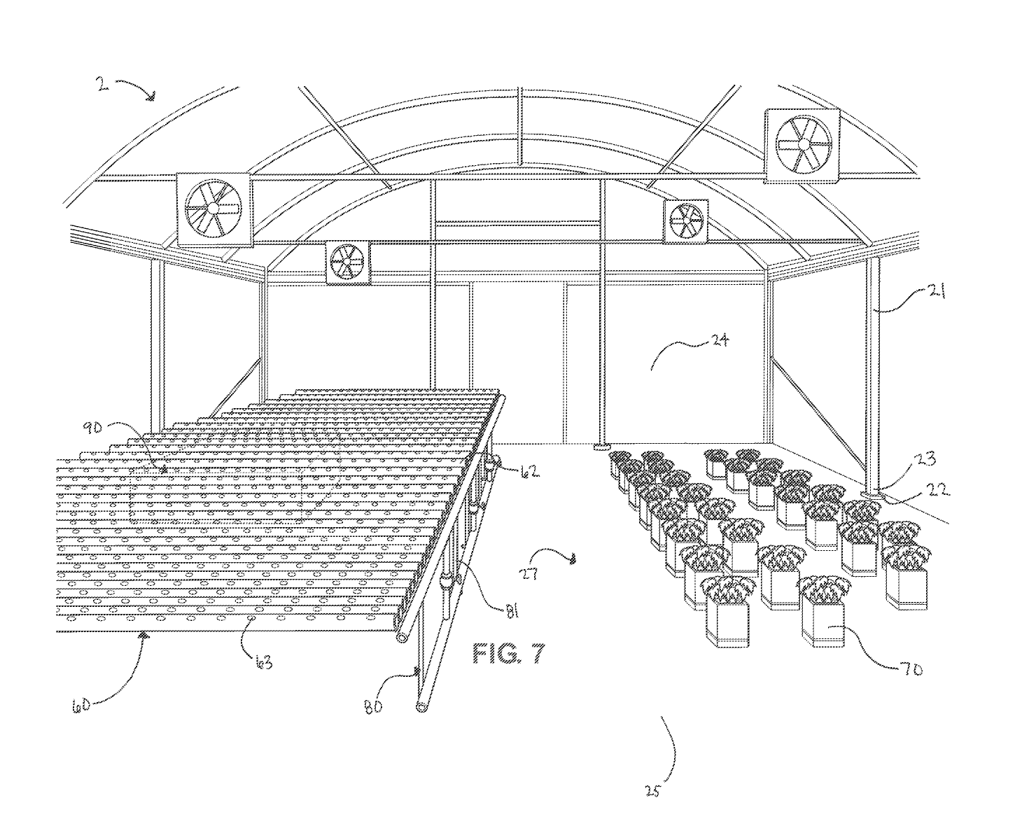

FIG. 7 depicts an internal view within inner chamber 25 of greenhouse member 2 of the present invention. When in operation, the hydroponic system of greenhouse assembly 100 is methodically unpacked from container member 1, installed and set-up, and is then integrated within greenhouse member 2, as per the instructions on an overlay covering 27. In addition, in order to encourage rapid deployment and assembly/disassembly and to prevent loss of equipment, greenhouse assembly 100 comprises a plurality of tables 60 for hydroponic crop propagation and production, wherein tables 60 are substantially collapsible in order to ensure proper orientation and configuration during assembly, installation, and disassembly and removal.

As illustrated in FIG. 7, greenhouse member 2 comprises growing table 60 and at least one bucket(s) 70 for use in growing vining crops, or any other similar item of vegetation. Although not illustrated in FIG. 7, greenhouse member 2 comprises a protective overlay 27 for use in covering a ground surface within greenhouse member 2. Overlay 27 provides a map, or a blueprint, for use in allowing a plumbing system, or hydroponic system, within greenhouse member to be installed and designating where each component of said plumbing system can be positioned, thereby eliminating a need for additional instructions or packaging within container member 1 of greenhouse assembly 100.

Generally located underneath table 60 and bucket(s) 70, ground covering 27 beneficially comprises a plurality of pre-drawn marks that encourage precise placement of equipment throughout greenhouse member 2 for consistent installations wherever portable greenhouse assembly 100 is located. Because the location and placement of each component part is the same in each installation of a greenhouse assembly 100, ancillary equipment and plumbing may be pre-built and included with shipment of container member 1 for use in rapid installation and consistent deployment.

Still referring to FIG. 7, a leg assembly 80 of table 60 is fastened to a base in such a manner as to allow for legs 81 of table 60 to fold up and connectably snap into proper alignment, wherein a plurality of leg assemblies 80 are installed in order to create table 60. Hydroponic tables 60 generally require legs 81 of a relatively shorter length that gradually decrease in length in order to create a relatively natural slope that allows for water to naturally flow by way of a gravitational force.

Additionally, although not depicted in FIG. 7, in order to help level propagation and growing tables 60, collapsible tables 60 are designed to use adjustable feet in order to raise and lower the table legs 81. Likewise, the propagation and growing table legs 81 are designed to allow for raising and lowering an entire table 60 for children, people with disabilities, or any other person, for ease of use.

Once tables 60 are installed, a hydroponic system is installed and plumbed within greenhouse member 2 of the present invention. In a preferred embodiment, a plurality of reservoirs 90 having a relatively, shorter, rectangular shape can be installed underneath tables 60, thereby providing a means for water and irrigation to be located inside greenhouse assembly 100 in order to protect the water from outside contamination and allow the water to function as insulation inside greenhouse assembly. Further, in a preferred embodiment, tables 60 comprise a plurality of channels 62 for use in hydroponic crop production, wherein channels substantially form a surface-like structure for tables 60. In addition, channels 62 comprise a plurality of bores 63 along outer surface of channels 62, thereby allowing water to flow through bores 63, through channels 62, and ultimately back through reservoirs 90, and thus, water filtration system 40 of the present invention.

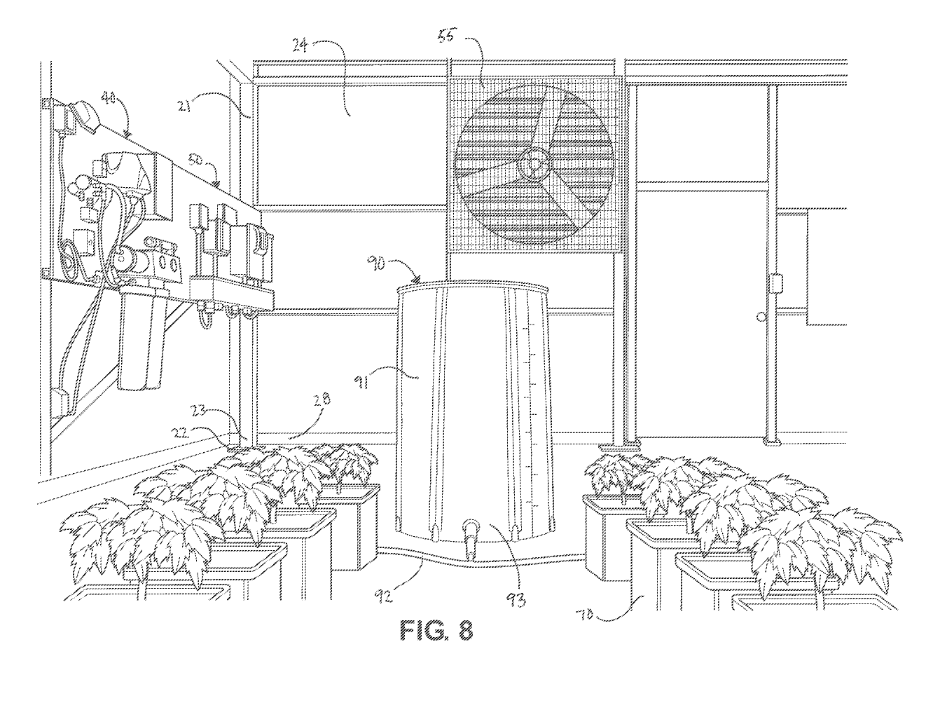

FIG. 8 depicts an internal view of inner space 25 within greenhouse member 2 of the present invention generally comprising electrical control system 50, water filtration system 40, and a standardized, gravity fed hydroponic bucket growing system with reservoir assembly 90. Further, FIG. 8 depicts electrical control system 50 and water filtration system 40 that are mechanically fastened to wall 24 of greenhouse member 2, along with any ancillary equipment, including an exhaust fan 55 that is controlled by electrical control system 50. Referring back to FIG. 4, ancillary devices, such as, for example, exhaust fan 55, that are equipped with a labeled, electrical “pig tail” of precise length are beneficially plugged into their pre-designated outlets at the base of the trough of electrical control system 50.

As illustrated in FIG. 8, bucket growing system with reservoir assembly 90 comprises a container 91 for use in storing water and tubing 92, wherein tubing 92 connectably attaches reservoir assembly 90 to a plurality of buckets 70 within greenhouse assembly 100. In operation, nutrient-dense water that is located within reservoir assembly 90 flows through tubing 92 at base 93 of reservoir 90 to each bucket 70, thereby providing a source of nutrition for vines or other vegetation that are growing within buckets 70.

Reservoir assembly 90, or portable water storage tank, is generally positioned within greenhouse member 2, especially during relatively colder temperatures or colder climates, and is plumbed from water filtration system 40. Reservoir assembly 90 is installed as a substantially inflatable tank 91, wherein reservoir comprises a relatively flexible pouch-like receptacle 91 that uses a collapsible frame member 93 for structure in order to provide water to the expanding and growing reservoir 90. Said reservoir assembly 90 is then able to hold water that has already been filtered for use in providing irrigation to plants, produce, and other vegetation within greenhouse assembly 100.

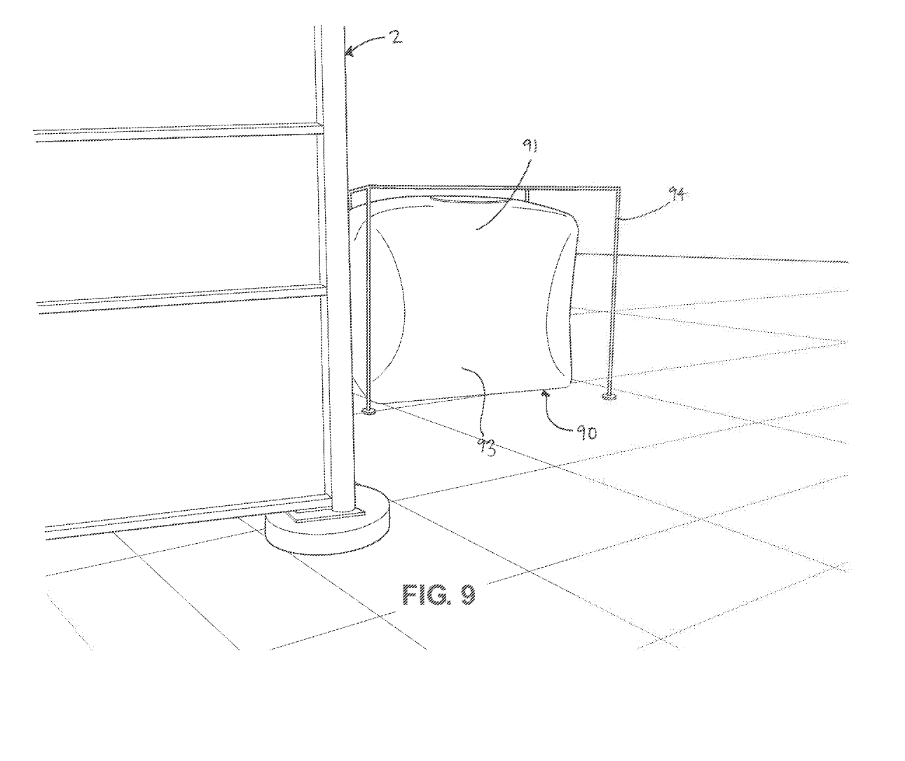

FIG. 9 depicts a front perspective view of an alternate embodiment of reservoir assembly 90, or water storage tank, of greenhouse assembly of the present invention. Water storage tank 90 comprises a collapsible reservoir 91 that is manufactured from a relatively flexible material and that is supported by a collapsible frame member 94. Further, water storage tank 90 is connected to water filtration system 40 within greenhouse member and can be located and stored within greenhouse member during colder temperatures or in relatively cooler climates (although not depicted in FIG. 9). Alternatively, as illustrated in FIG. 9, water storage tank 90 can be installed outside of greenhouse member 2 by way of a liner that is designed to be reused in order to store water.

Although not depicted in FIG. 9, the plumbing from water filtration system 40 to water storage tank 90 to a plurality of growing reservoirs within greenhouse member 2 can be installed by way of a plurality of pre-designed plumbing fittings that are included within container member 1 upon initial delivery, along with appropriate installation and assembly instructions, thereby expediting installation and eliminating a need for a specialized plumber technician.

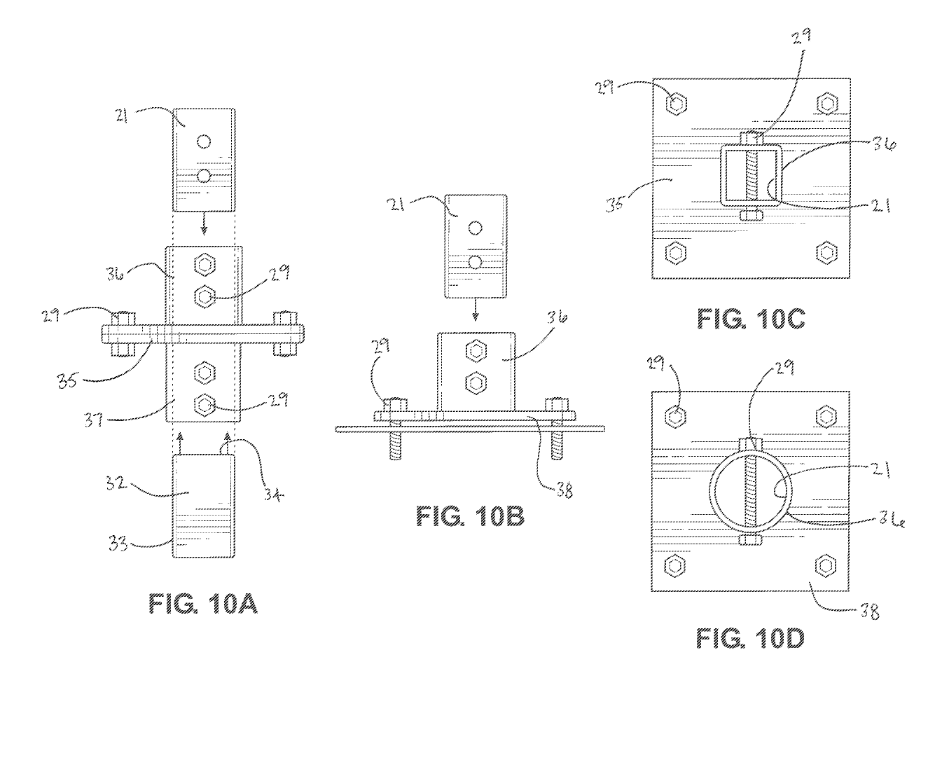

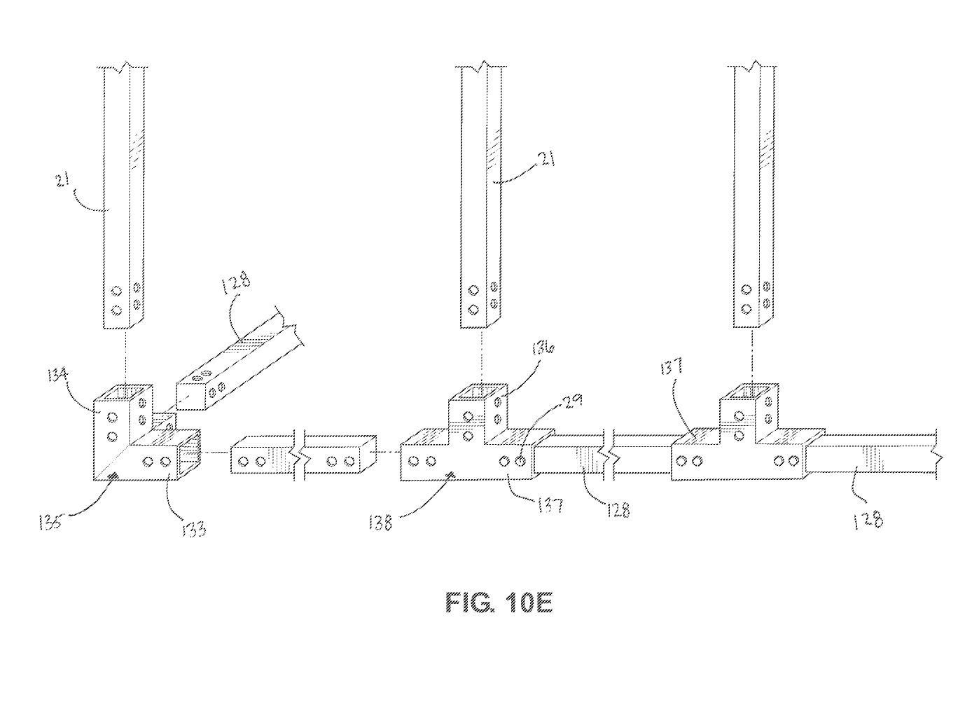

FIG. 10 depicts an illustration of a plurality of mating connections wherein posts 21 can be coupled to a ground surface during greenhouse installation. For example, in a cylindrical screw connection, greenhouse member 2 comprises a plurality of substantially cylindrical screws 32 for use in installing greenhouse member 2, wherein posts 21 are able to mate into cylindrical screws 32. Additionally, in a concrete connection, greenhouse member 2 comprises a plurality of supports 38 for use in installing greenhouse member 2 into a ground surface, wherein posts 21 are able to mate into supports 38. As a result, said mating connections create a temporary greenhouse structure that can be removed when necessary.

In a preferred embodiment, as illustrated in FIG. 10a, during a helical screw connection means, a plurality of cylinders 32 are first drilled into a ground surface at designated locations. Cylinders 32 comprise an outer diameter 33 and an inner diameter 34, wherein inner diameter 34 has a substantially helical connection for use as a screw-like attachment means. A connection bracket 35 is attachably connected and screwed into cylinders 32, and is thus, further secured into place via a plurality of fasteners 29, or bolts, or any other secure attachment means. Connection bracket 35 comprises a relatively planar surface having a column extending in a relatively upward direction 36 and a column extending in a relatively downward direction 37 from said planar surface. Downward extending column 37 attachably connects to said helical screw cylinder 32. Upward extending column 36 allows for a connection point for greenhouse posts 21. As a result, greenhouse posts 21 of greenhouse member 2 can be fastened to upward extending column 36 of helical screw connection means, thereby providing a temporary structure that can be assembled and/or disassembled as necessary.

Referring to FIG. 10b, in a preferred embodiment, during a concrete connection means, a plurality of bases 38 are secured into a ground surface by way of fasteners 29, or bolts. Bases 38 comprise a substantially planar surface, having a relatively upwardly extending column 36 for use as a connection point for greenhouse posts 21. Upward extending column 36 is received within greenhouse post 21, wherein column 36 and post 21 and further secured together by way of fasteners 29, or bolts.

FIG. 10c depicts an aerial view of helical screw connection. Helical screw connection comprises connection bracket 35 having a relatively planar surface with column extending in a relatively upward direction 36, substantially perpendicular to connection bracket 35. Greenhouse post 21 is then slidably joined to connection bracket 35, wherein upwardly extending column 36 is received within greenhouse post 21, and thus, further secured via fasteners 29, or bolts.

FIG. 10d depicts an aerial view of concrete connection means. Concrete connection comprises connection bracket 38 having a relatively planar surface with column extending in a relatively upward direction 36, substantially perpendicular to connection bracket 38. Greenhouse post 21 is then slidably connected to upward extending column 36 of connection bracket 38, wherein upwardly extending column 36 is received within greenhouse post 21, and thus, further secured via fasteners 29, or bolts.

FIG. 10e depicts an alternate connection means of greenhouse assembly comprising a plurality of substantially “L” shaped corner brackets 135 and a plurality of substantially “T” shaped linking brackets 138 that, when mechanically fastened, form a substantial skeletal structure of greenhouse member 2, wherein a base 28 of greenhouse member 2 becomes a single unit that mitigates a potential need for piers, helical screws, and/or any other type of foundational support.

Still referring to FIG. 10e, relatively upward extending column 136 of linking bracket 138 is received within post 21, wherein column 136 and post 21 are further secured together by way of fasteners 29, or any other similar attachment means. Relatively horizontal extending column 137 of linking bracket 138 is received within base post 128 of greenhouse member 2, wherein column 137 and base post 128 are further secured together via fasteners 29.

Additionally, relatively upward extending column 134 of corner bracket 135 is received within post 21, wherein column 134 and post 21 are further secured together via fasteners 29. Relatively horizontal extending column 133 of corner bracket 135 is received within base post 128 of greenhouse member 2, wherein horizontal column 133 and base post 128 are further secured together via fasteners 29. Upon complete assembly and fastening of base posts 128 to horizontal base columns 137 of linking bracket 138 and horizontal base columns 133 of corner bracket 135, a perimeter of base 28 of skeletal structure is able to provide foundational and structural support for greenhouse member 2.

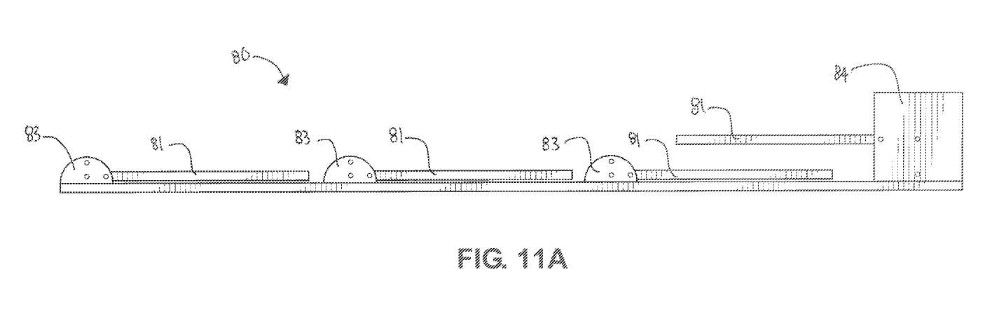

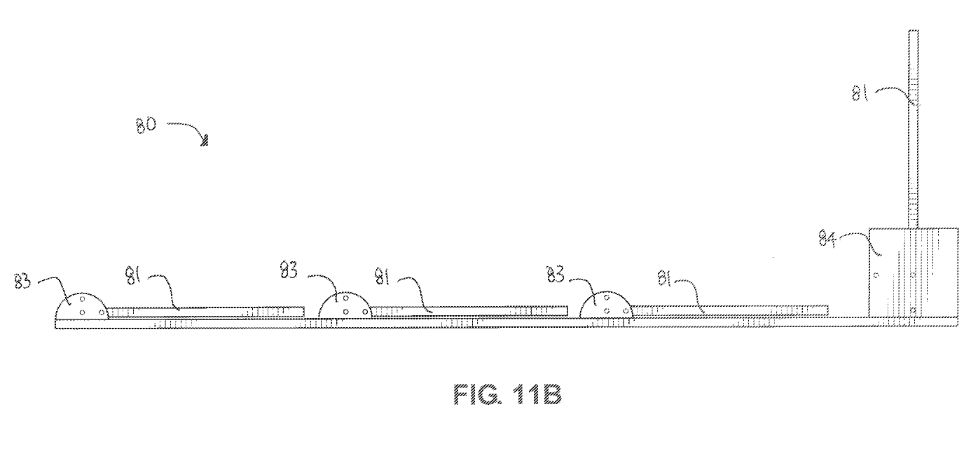

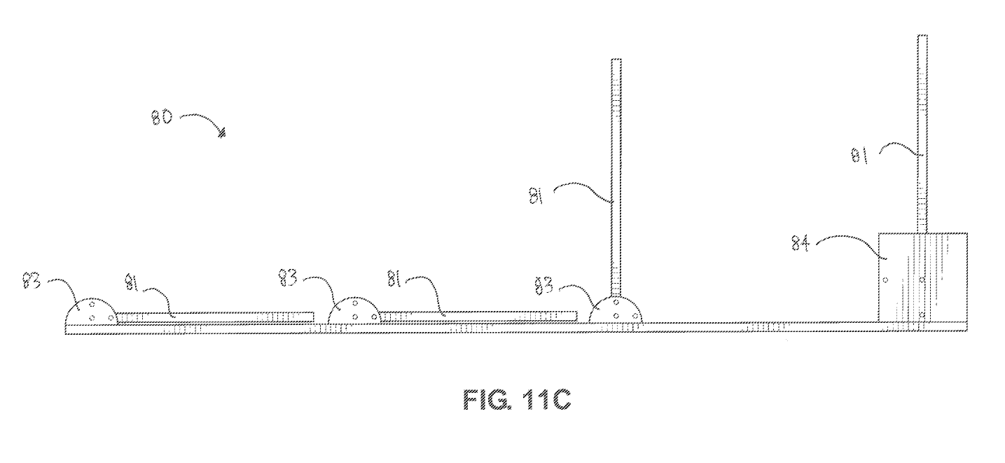

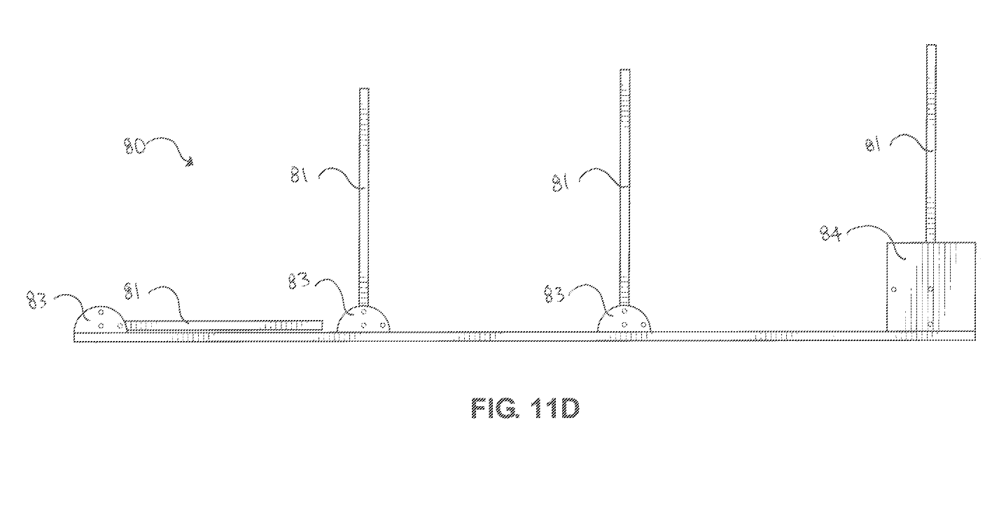

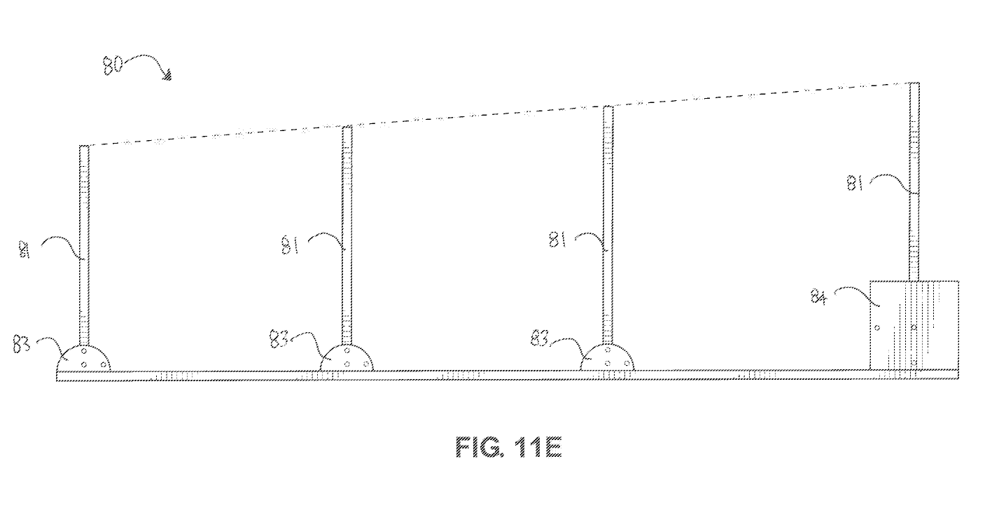

FIG. 11 depicts a side view of leg assembly 80 of tables 60 within greenhouse member 2 of the present invention. When in operation, the hydroponic system of greenhouse assembly 100 is methodically unpacked from container member 1, installed and set-up, and is then integrated within greenhouse member 2, as per the instructions on overlay covering 27. In order to encourage rapid deployment and assembly/disassembly and to prevent loss of equipment, greenhouse assembly 100 comprises tables 60 for hydroponic crop propagation and production, wherein said tables 60 are collapsible in order to ensure proper orientation and configuration during fabrication.

As depicted in FIG. 11, leg assembly 80 of table 60 is fastened to a base in such a manner as to allow for legs 81 of table 60 to fold up and connectably snap into proper alignment. A plurality of leg assemblies 80 are installed in order to create the table. Hydroponic tables 60 generally require legs 81 of a relatively shorter length in order to create a relatively natural slope that allows for water to naturally flow by way of a gravitational force. A fastening system comprises a plurality of—typically three (3)—fasteners 83 of a relatively similar shape and at least one fastener 84 of a different shape that allows legs 81 to be able to fold onto each other, thereby ensuring that a substantially shorter side of table 60 is correctly installed by way of aligning the particular shapes of the fasteners 83, 84.

Additionally, in order to help level propagation and growing tables 60, collapsible tables 60 are designed to use adjustable feet in order to raise and lower table legs 81. Likewise, the propagation and growing table legs 81 are designed to allow for raising and lowering an entire table 60 for children, people with disabilities, or any other person, for ease of use.

FIG. 11a depicts a side view of a preferred embodiment of leg assembly 80 in an unassembled configuration. FIG. 11b depicts a side view of leg assembly 80 with a single leg 81 assembled into place. FIG. 11c depicts a side view of leg assembly 80 with at least two legs 81 assembled into place. FIG. 11d depicts a side view of leg assembly 80 with a plurality of legs 81 assembled into place. FIG. 11e depicts a side view of leg assembly 80 with all of the legs 81 assembled into place. Still referring to FIGS. 11a-11e, during assembly, when table legs 81 are set up, and thus, stand up in a relatively vertical position, table legs 81 form a relatively gradual slope from tallest leg to shortest leg. This gradual slope of legs 81 ultimately allows tables 60 to have a relatively gradual slope, therefore providing additional support to table 60 and allowing water to flow along table 60 by way of a gravitational force pulling water in a relatively downward direction, thereby bringing water, and thus, nutrients to a variety of plants and other vegetation within greenhouse assembly.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A portable assembly for growing plants comprising:
a) a container defining an inner space;
b) a greenhouse assembly adapted to fit within said inner space, wherein said greenhouse assembly is adapted to be removed from said inner space and assembled; and
c) at least one solar photovoltaic panel for providing electricity to said greenhouse assembly.

2. The portable assembly of claim 1, wherein said at least one solar photovoltaic panel is attached to said container.

3. The portable assembly of claim 2, wherein said at least one solar photovoltaic panel can alternate between a first substantially collapsed position and a second deployed position.

4. The portable assembly of claim 1, wherein said greenhouse assembly further comprises:
a) anchor members adapted to securely attach to an underlying surface;
b) a plurality of frame members attached to said anchor members;
c) at least one glazing member supported by said frame members, wherein said at least one glazing member is transparent or translucent.

5. The portable assembly of claim 4, further comprising a stringer member disposed between frame members.

6. The portable assembly of claim 4, further comprising roof frame members attached to said frame members.

7. The portable assembly of claim 4, wherein said at least one glazing member comprises at least one polycarbonate sheet or polyethylene film.

8. The portable assembly of claim 1, further comprising a water filtration assembly.

9. The portable assembly of claim 1, further comprising an air handling system.

10. A method for growing plants comprising:
a) moving a container having an inner space to a predetermined grow area;
b) unloading a greenhouse assembly from said inner space; and
c) assembling said greenhouse assembly on said predetermined grow area.

11. The method for growing plants recited in claim 10, wherein said container further comprising at least one solar photovoltaic panel for providing electricity to said greenhouse assembly.

12. The method of claim 10, wherein said at least one solar photovoltaic panel can alternate between a first substantially collapsed position and a second deployed position.

13. The method of claim 10, wherein said greenhouse assembly further comprises:
a) anchor members adapted to securely attach to an underlying surface;
b) a plurality of frame members attached to said anchor members;
c) at least one glazing member supported by said frame members, wherein said at least one glazing member is transparent or translucent.

14. The method of claim 13, wherein said greenhouse assembly further comprises at least stringer member disposed between said frame members.

15. The method of claim 13, wherein said greenhouse assembly further comprises roof frame members attached to said frame members.

16. The method of claim 13, wherein said at least one glazing member comprises at least one polycarbonate sheet or polyethylene film.

17. The method of claim 13, wherein said greenhouse assembly further comprises a water filtration assembly.

18. The method of claim 13, wherein said greenhouse assembly further comprises an air handling system.
